(19) United States
(12) Patent Application Publication
(10) Pub. No.: US 2015/0261063 A1
(43) Pub. Date: Sep. 17, 2015

(54) OPTICAL MODULE

(71) Applicant: Fujitsu Optical Components Limited, Kawasaki-shi (JP)

(72) Inventor: Masaki SUGIYAMA, Sagamihara (JP)

(73) Assignee: Fujitsu Optical Components Limited, Kawasaki (JP)

(21) Appl. No.: 14/628,744

(22) Filed: Feb. 23, 2015

(30) Foreign Application Priority Data
Mar. 12, 2014 (JP) 2014-048863

(51) Int. Cl. G02F 1/225

(52) U.S. Cl. CPC G02F 1/225; G02F 2001/212

(57) ABSTRACT

An optical module includes a first substrate and a second substrate. The first substrate includes a first electrode and a first mark. The second substrate includes a second electrode and a second mark. The second substrate is formed so that at least part of the first mark is exposed in the vicinity of the second mark when the second electrode is electrically connected to the first electrode.

### CROSS-REFERENCE TO RELATED APPLICATION

This application is based upon and claims the benefit of priority of the prior Japanese Patent Application No. 2014-048863, filed on Mar. 12, 2014, the entire contents of which are incorporated herein by reference.

### FIELD

The embodiments discussed herein are related to an optical module.

### BACKGROUND

In recent years, an increase in the modulation speed and an increase in the configuration scale of an optical module such as an optical modulator have been in progress along with an increase in the capacity of an optical transmission system. Therefore, in an optical transmitter with an optical module mounted therein, it is desirable that a plurality of Mach-Zehnders forming optical waveguides be integrated in a single chip in order to achieve a size reduction. In an optical module, optical waveguides are formed in parallel with one another by four Mach-Zehnders, for example. Two signal electrodes and two ground electrodes are patterned on each of the optical waveguides. The optical module generates a multilevel-modulated signal by inputting electric signals different from each other to the two signal electrodes. In such an optical module, all the electric signal input units are disposed on one side of a package in order to facilitate the mounting of the input unit (such as a coaxial connector) and to reduce the mounting area thereof.

In the optical module with the input units disposed on one side thereof, an electric signal such as an RF (Radio Frequency) signal is inputted thereto via a coaxial connector provided on the side surface of the package. Moreover, a coaxial adaptor for inputting an external electric signal is connected to the coaxial connector. The optical module, however, needs to increase a pitch between the signal electrodes to which electric signals are inputted according to the width of the coaxial adaptor. Thus, when the number of channels is increased, the mounting area is correspondingly increased.

[Patent document 1] Japanese Laid-open Patent Publication No. 2002-268574

[Patent document 2] Japanese Laid-open Patent Publication No. 2007-188979

In order to suppress the aforementioned increase in mounting area, a surface-mount optical module in which an electric signal is inputted from a PCB (Printed Circuit Board) side via an FPC (Flexible Printed Circuit) provided in a package has been developed. In such an optical module, an electrode pattern on the PCB and an electrode pad on the FPC are connected to each other with a solder in order to input an electric signal thereto. This eliminates a need for the coaxial adaptor. Thus, a pitch between the signal electrodes to which electric signals are inputted can be reduced, thereby reducing the mounting area thereof. As a result, a reduction in the size of the optical transmitter can be achieved.

However, it is difficult to accurately place the electrode pad at an appropriate position on the electrode pattern since the connection between the electrode pattern on the PCB and the electrode pad on the FPC is generally performed by a visual soldering operation. If a displacement occurs between the position of the electrode pattern on the PCB and the position of the electrode pad on the FPC, an impedance mismatch is generated at the connection between the PCB and the FPC. Such a mismatch becomes a factor for pushing the characteristic impedance of each signal electrode at the connection away from an ideal value of 50Ω. Especially in an optical module handling high-frequency signals such as an optical modulator, the aforementioned impedance mismatch increases the reflection of high-frequency signals, thereby resulting in deterioration in the high-frequency characteristics thereof.

### SUMMARY

According to an aspect of the embodiments, an optical module includes: a first substrate that includes a first electrode and a first mark; and a second substrate that includes a second electrode and a second mark. The second substrate is formed so that at least part of the first mark is exposed in the vicinity of the second mark when the second electrode is electrically connected to the first electrode.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a top view illustrating a configuration of an optical module according to a present embodiment;

FIG. 2A is a partial cross-sectional view illustrating an example of a connection between a PCB and an FPC;

FIG. 2B is a partial cross-sectional view illustrating another example of the connection between the PCB and the FPC;

FIG. 3 is a diagram illustrating a relationship between a displacement at the connection between the PCB and the FPC and a characteristic impedance;

FIG. 4 is a top view illustrating the connection between the PCB and the FPC according to the present embodiment;

FIG. 5 is a partial cross-sectional view illustrating the connection between the PCB and the FPC according to the present embodiment;

FIG. 6 is a top view illustrating a connection between the PCB and the FPC according to a first modified embodiment;

FIG. 7A is a cross-sectional view taken along line A-A′ of FIG. 6;

FIG. 7B is a cross-sectional view taken along line B-B′ of FIG. 6;

FIG. 8 is a top view illustrating a connection between the PCB and the FPC according to a second modified embodiment;

FIG. 9 is a top view illustrating a connection between the PCB and the FPC according to a third modified embodiment;

FIG. 10 is a top view illustrating a connection between the PCB and the FPC according to a fourth modified embodiment;

FIG. 11 is a top view illustrating a connection between the PCB and the FPC according to a fifth modified embodiment; and

FIG. 12 is a diagram illustrating a configuration of a transmitter in which the optical module according to any one of the above-described embodiment and modified embodiments is mounted.

### DESCRIPTION OF EMBODIMENTS

Preferred embodiments will be explained with reference to accompanying drawings. Note that the optical module disclosed by the present application is not limited to the following embodiments.

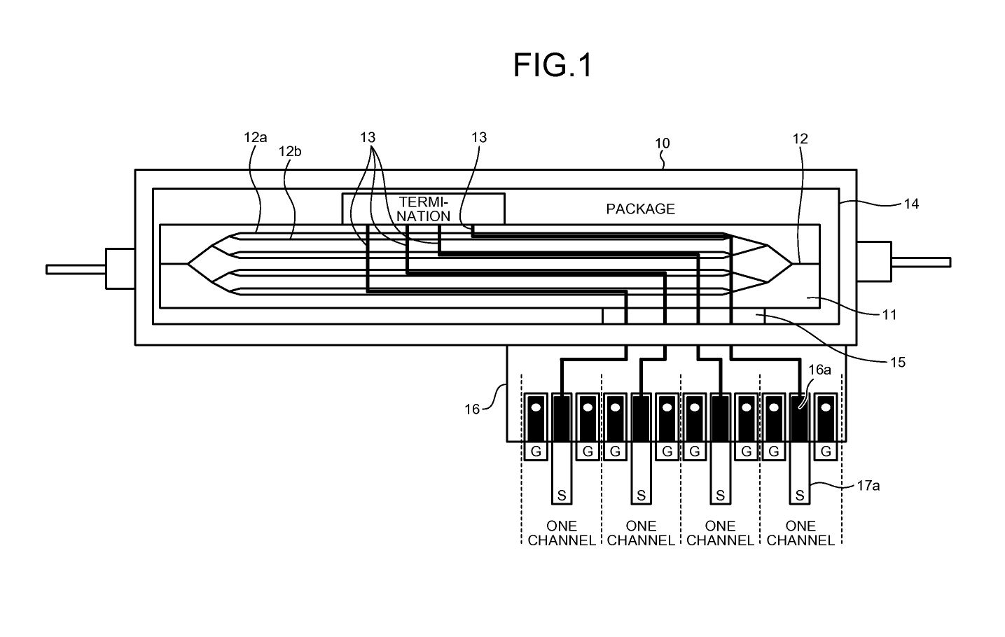

A configuration of an optical module according to an embodiment disclosed by the present application will be described first. FIG. 1 is a top view illustrating the configuration of an optical module 10 according to the present embodiment. As illustrated in FIG. 1, the optical module 10 is formed by providing electrodes 13 in the vicinity of optical waveguides 12 formed on a crystal substrate 11. The crystal substrate 11 is made of an electro-optic crystal such as LiNbO₃ (LN) or LiTaO₂. The optical waveguide 12 is formed by forming a metal film such as Ti and subjecting the metal film to thermal diffusion or by performing patterning and then proton exchange in benzoic acid. The optical waveguides 12 constitute a Mach-Zehnder interference system and the electrodes 13 are provided on the parallel waveguides of the Mach-Zehnder.

Since the electrode 13 utilizes a refractive index change due to an electric field in a z-axis direction, the electrode 13 is disposed directly above the optical waveguide 12. The electrode 13 is a coplanar electrode formed by patterning a signal electrode and a ground electrode on the optical waveguide 12. In order to prevent light propagating through the optical waveguide 12 to be absorbed by the signal electrode and the ground electrode, the optical module 10 has a buffer layer between the crystal substrate 11 and the electrode 13. The buffer layer is made of SiO₂ or the like with a thickness of about 0.2 to 2 μm.

When the optical module 10 is driven at high speed, terminations of the signal electrode and the ground electrode are connected to each other with a resistor so as to form a traveling-wave electrode and a microwave signal is applied to an input side thereof. At this time, the refractive indexes of the two optical waveguides 12 (for example, optical waveguides 12a and 12b) constituting a Mach-Zehnder are changed by +Δna and −Δnb, respectively, for example, due to the electric field. Along with such a change, a phase difference between the optical waveguides 12 is also changed. As a result, a phase-modulated signal light is outputted from the optical waveguide 12 due to Mach-Zehnder interference. The optical module 10 can obtain a high-speed optical response property by controlling the effective refractive index of the microwave by means of changing a cross-sectional shape of the electrode 13 so as to match the speeds of the light and the microwave.

According to the optical module 10, a package 14 housing the crystal substrate 11, the optical waveguide 12, and the electrode 13 is provided with an FPC 16 via a relay board 15 as illustrated in FIG. 1. If a high-frequency wave propagation loss is large in the electrode on the FPC 16, the modulation bandwidth is narrowed, thereby increasing the drive voltage thereof. Thus, in the optical module 10 handling high-frequency signals, it is desirable that the FPC 16 have a shortest possible length in order to reduce the high-frequency wave loss. Moreover, a PCB is connected to the FPC 16. If an impedance mismatch is generated in this connection, however, the reflection of the high-frequency signal is increased and the transmission frequency bandwidth is therefore narrowed. In order to prevent this, it is important that a characteristic impedance at a connection between an electrode pad 16a on the FPC 16 and an electrode pattern 17a of the PCB approximates 50Ω as close as possible.

An electric signal such as an RF signal outputted from the electrode pattern 17a of the PCB is inputted into the electrode 13 via the electrode pad 16a of the FPC 16 attached to the package 14. The PCB (electrode pattern) and the FPC 16 (electrode pad) are connected to each other with a solder. Therefore, as compared with the case where a coaxial adapter is employed, the pitch between the electrode pads 16a can be narrowed, thereby allowing for high-density mounting.

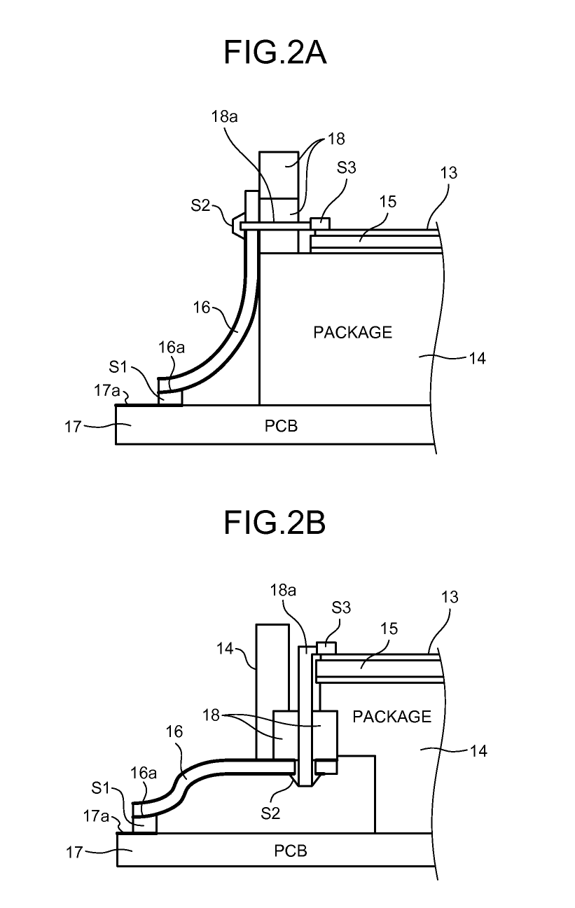

FIG. 2A is a partial cross-sectional view illustrating an example of the connection between a PCB 17 and the FPC 16. As illustrated in FIG. 2A, the electrode pattern 17a of the PCB 17 and one end (electrode pad 16a side) of the FPC 16 are connected to each other with a solder S1. The FPC 16 extends upwardly and is in contact with the package 14 at the other end thereof. Also, the FPC 16 is fixed to a coaxial connector 18 on the package 14 by means of a lead pin 18a and solders S2 and S3. Moreover, the FPC 16 is electrically connected to the relay board 15 and the electrode 13 via the lead pin 18a. This enables an electric signal such as an RF signal inputted into the electrode pad 16a from the electrode pattern 17a to reach the lead pin 18a via the FPC 16 and then flow through the electrode 13 via the relay board 15.

FIG. 2B is a partial cross-sectional view illustrating another example of the connection between the PCB 17 and the FPC 16. As illustrated in FIG. 2B, the electrode pattern 17a of the PCB 17 and one end (electrode pad 16a side) of the FPC 16 are connected to each other with the solder S1. The FPC 16 extends laterally and is in contact with the package 14 at the other end thereof. Also, the FPC 16 is fixed to the coaxial connector 18 interposed between the packages 14 by means of the lead pin 18a and the solders S2 and S3. Moreover, the FPC 16 is electrically connected to the relay board 15 and the electrode 13 via the lead pin 18a. This enables an electric signal such as an RF signal inputted into the electrode pad 16a from the electrode pattern 17a to reach the lead pin 18a via the FPC 16 and then flow through the electrode 13 via the relay board 15.

In any of these configurations illustrated in FIGS. 2A and 2B, it is desirable that the length of the electrode pad 16a of the FPC 16 be as short as about 1 mm in order to suppress the propagation loss of the electric signal. Moreover, it is important for an operator of the soldering to align the electrode pad 16a of the FPC 16 with the electrode pattern 17a of the PCB 17 with high accuracy in order to make the characteristic impedance at the connection between the PCB 17 and the FPC 16 close to the ideal value of 50Ω.

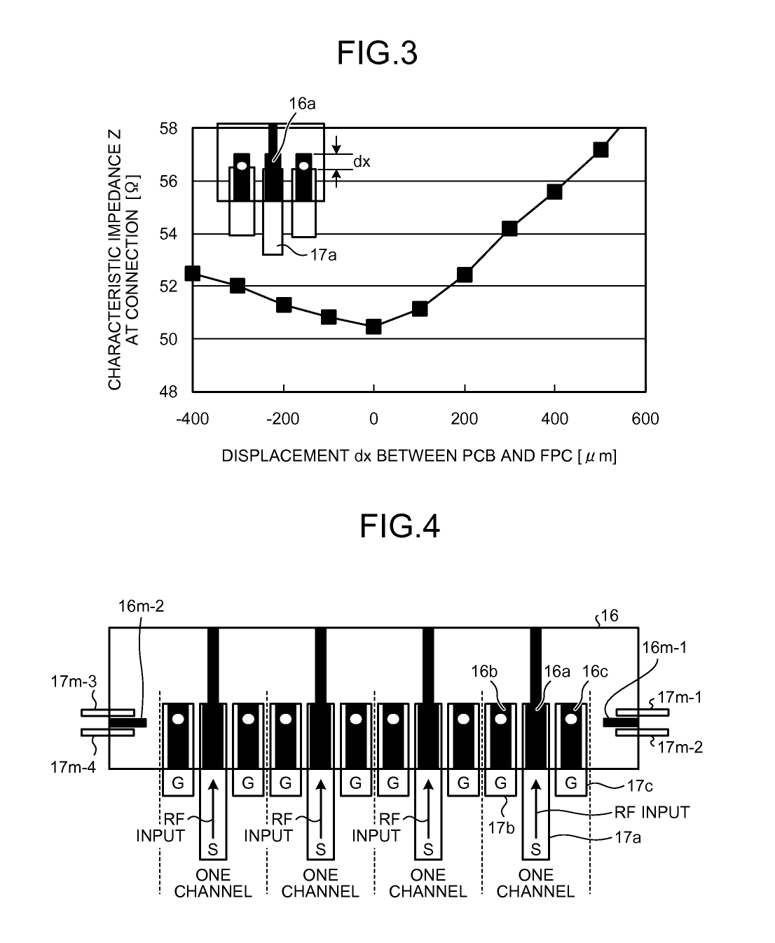

FIG. 3 is a diagram illustrating a relationship between a displacement dx at the connection between the PCB 17 and the FPC 16 and a characteristic impedance Z. In FIG. 3, the x-axis defines the displacement dx (unit: μm) at the connection between the electrode pad 16a of the FPC 16 and the electrode pattern 17a of the PCB 17. The y-axis thereof defines the characteristic impedance Z (unit: Ω) at the connection. As illustrated in FIG. 3, when an upper end of the electrode pad 16a coincides with an upper end of the electrode pattern 17a (when the displacement dx=0 μm), the characteristic impedance Z approximates the ideal value of 50Ω. With an increase in the displacement dx away from 0, the characteristic impedance Z is further deviated from 50Ω. As a result, reflection for the high-frequency wave is increased, thereby deteriorating the transmission frequency bandwidth. Thus, it becomes important to suppress the displacement of the characteristic impedance Z as much as possible. For example, in order to keep the displacement of the characteristic impedance Z within 1Ω, it is requested to suppress the displacement dx at the connection to a level of about ±100 μm.

In the optical module 10 according to the present embodiment, alignment marks are provided on the PCB 17 and the FPC 16 in order to improve alignment accuracy at the connection and thereby suppress the bandwidth deterioration. FIG. 4 is a top view illustrating the connection between the PCB 17 and the FPC 16 according to the present embodiment. As illustrated in FIG. 4, at the connection between the PCB 17 and the FPC 16, the electrode pad 16a on the rear surface of the FPC 16 is connected onto the electrode pattern 17a on the front surface of the PCB 17 by means of soldering so as to form a signal pattern S. Furthermore, at both sides of the signal pattern S, other electrode pads 16b and 16c are connected onto other electrode patterns 17b and 17c, respectively, by means of soldering so as to form ground patterns G. These one signal pattern S and two ground patterns G constitute one channel.

As illustrated in FIG. 4, alignment marks 16m-1 and 16m-2 are provided on the front surface of the FPC 16, one for each end thereof, with the longitudinal direction thereof aligned with a direction perpendicular to the electrode pad 16a formed on the rear surface of the FPC 16. Corresponding to these alignment marks, alignment marks 17m-1, 17m-2, 17m-3, and 17m-4 are provided on the front surface of the PCB 17, two for each end thereof, with the longitudinal direction thereof aligned with a direction perpendicular to the electrode pattern 17a formed on the front surface of the PCB 17. The operator of the soldering adjusts the position of the FPC 16 so that the alignment mark 16m-1 is disposed between the alignment marks 17m-1 and 17m-2. Similarly, the operator of the soldering adjusts the position of the FPC 16 so that the alignment mark 16m-2 is disposed between the alignment marks 17m-3 and 17m-4. Such an operation minimizes the displacement dx. Note that while the adjustment by the operator may be performed visually, such an adjustment may be performed with the use of an image or the like.

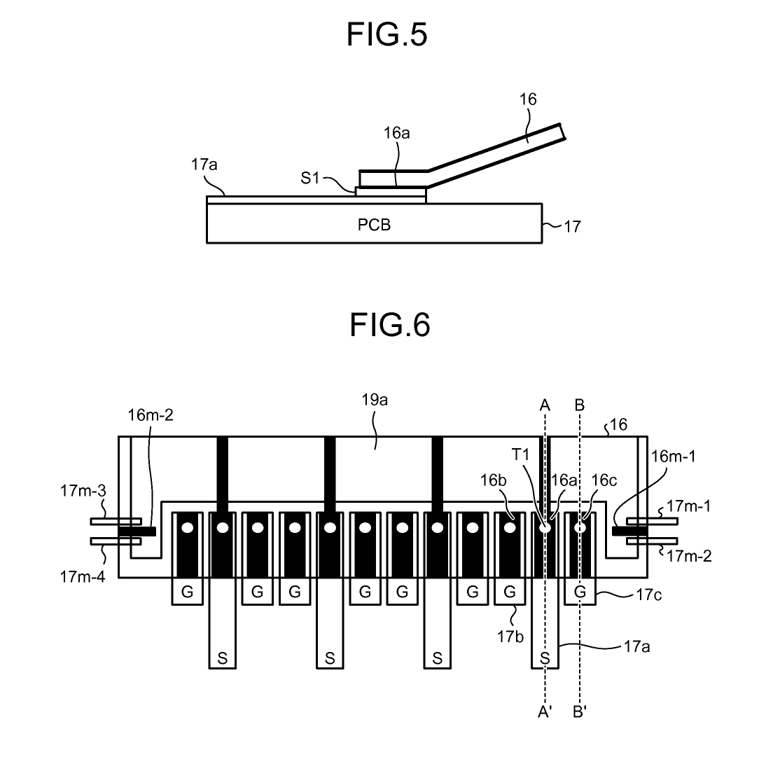

FIG. 5 is a partial cross-sectional view illustrating the connection between the PCB 17 and the FPC 16 according to the present embodiment. As illustrated in FIG. 5, at the connection between the PCB 17 and the FPC 16 in the optical module 10 according to the present embodiment, the electrode pattern 17a formed on the front surface of the PCB 17 and the electrode pad 16a formed on the rear surface of the FPC 16 are electrically connected to each other via the solder S1.

As illustrated in FIG. 5, solder connection is made only at the portion of the FPC 16 to be connected with the PCB 17. Therefore, it is desirable that the alignment marks 16m-1 and 16m-2 be formed in a non-tilted region (for example, in the vicinity of the connection) on the front surface of the FPC 16 within a range so as not to complicate the soldering operation as illustrated in FIG. 4.

As described above, the optical module 10 includes the PCB 17 and the FPC 16. The PCB 17 includes the electrode patterns 17a and the alignment marks 17m-1 and 17m-2 formed on the same surface (for example, the front surface) as the electrode patterns 17a. The FPC 16 includes the electrode pads 16a and the alignment mark 16m-1 formed on a surface (for example, the front surface) different from the electrode pads 16a. The FPC 16 is formed so that at least part of the alignment marks 17m-1 and 17m-2 is exposed in the vicinity of the alignment mark 16m-1 when the electrode pad 16a is electrically connected to the electrode pattern 17a.

Moreover, in the optical module 10, relative positional accuracy between the electrode pad 16a and the electrode pattern 17a and the alignment marks 16m-1, 16m-2, 17m-1, 17m-2, 17m-3, and 17m-4 is important. Therefore, it is desirable that the alignment marks 16m-1, 16m-2, 17m-1, 17m-2, 17m-3, and 17m-4 be made of the same material (for example, copper foil) as the electrode pad 16a and the electrode pattern 17a so that the alignment marks 16m-1, 16m-2, 17m-1, 17m-2, 17m-3, and 17m-4 can be formed with a step same as or close to the step of forming the electrode pad 16a and the electrode pattern 17a.

Thus, operability when the operator of the soldering solders the electrode pad 16a to the electrode pattern 17a is improved. Therefore, alignment accuracy between the electrode pad 16a and the electrode pattern 17a, for example, is improved. As a result, an impedance mismatch at the connection between the FPC 16 and the PCB 17 is suppressed and the characteristic impedance Z at the connection therefore approximates the ideal value of 50Ω. This suppresses the reflection of the high-frequency signal at the connection between the FPC 16 and the PCB 17. Therefore, the high-frequency characteristics are improved. As a result, deterioration in the transmission frequency bandwidth is suppressed.

### First Modified Embodiment

The first modified embodiment will be described next. An optical module according to the first modified embodiment has a configuration similar to that of the optical module 10 according to the above-described embodiment except that the FPC 16 has a cover material (for example, a coverlay) on the front surface thereof. Therefore, in the first modified embodiment, components common to those of the above-described embodiment will be denoted by the same reference numerals and the detailed description thereof will be omitted.

The FPC 16 is made of polyimide or the like, for example, in order to provide flexibility thereto. Therefore, the FPC 16 has a lower level of adhesion with copper foil formed on the front surface or rear surface thereof as compared to the PCB 17. The electrode pad 16a, the electrode pattern 17a, the alignment marks 16m-1 and 16m-2, and the alignment marks 17m-1, 17m-2, 17m-3, and 17m-4 are made of copper foil, for example. Thus, especially in the FPC 16, the electrode pad 16a and the alignment marks 16m-1 and 16m-2 are more likely to be separated from each other.

From the perspective of suppressing such separation, it is desirable that the electrode pad 16a and the alignment marks 16m-1 and 16m-2 be formed with a large width. In order to reduce their formation space or due to difficulty in their fabrication or the like, however, the width of the electrode pad 16a or the alignment marks 16m-1 and 16m-2 is generally in a range of about 100 to 300 μm. In view of this, a cover material is formed on the front surface of the FPC 16 in the first modified embodiment in order to prevent the alignment marks 16m-1 and 16m-2 from being separated from the front surface of the FPC 16. Note that a cover material is formed also on the rear surface of the FPC 16 in order to prevent the electrode pad 16a and the like from being separated.

FIG. 6 is a top view illustrating a connection between the PCB 17 and the FPC 16 according to the first modified embodiment. As illustrated in FIG. 6, a cover material 19a is formed on the front surface of the FPC 16 so as to cover part of the alignment marks 16m-1 and 16m-2. This makes it possible to suppress the separation of the alignment marks 16m-1 and 16m-2 from the front surface of the FPC 16 due to the contact of a soldering iron therewith, a high temperature, or the like, even when the width of the alignment marks 16m-1 and 16m-2 is small. If the alignment marks 16m-1 and 16m-2 are covered by the cover material 19a, however, the operator of the soldering has difficulty in visually checking the alignment marks 16m-1 and 16m-2. Thus, there is a possibility of deteriorating the operability thereof.

In view of this, the cover material 19a covers not the entire alignment marks 16m-1 and 16m-2 but only portions thereof close to the inner side of the FPC 16 as illustrated in FIG. 6. In other words, the cover material 19a is formed so that the alignment marks 16m-1 and 16m-2 are exposed only at edge portions of the FPC 16. This makes it possible to improve the visibility of the operator and facilitate the visual checking since the alignment marks 16m-1 and 16m-2 are completely exposed near an outline of the FPC 16. Therefore, the optical module 10 can suppress the separation of the alignment marks 16m-1 and 16m-2 without reducing the operability of the soldering.

Note that the width of the alignment marks 16m-1 and 16m-2 is not necessarily uniform. The width of the portion covered by the cover material 19a may be formed so as to be greater than that of the other portions. Moreover, by providing a through hole in the portion with the wider width, the possibility for the separation of the alignment marks 16m-1 and 16m-2 from the FPC 16 can be further reduced. Note that the through hole is not necessarily provided one for each of the alignment marks 16m-1 and 16m-2. Two or more through holes may be provided for each of the alignment marks 16m-1 and 16m-2. Moreover, the cover material 19a for covering the alignment marks 16m-1 and 16m-2 may be made of a transparent or semitransparent material so as not to block the visibility of the covered portion.

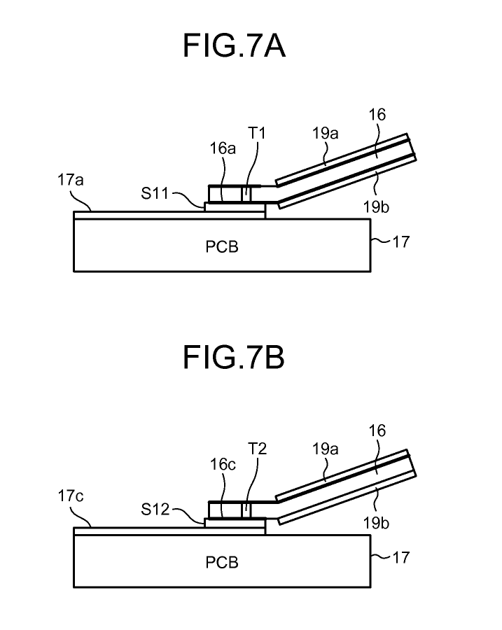

FIG. 7A is a cross-sectional view taken along line A-A′ of FIG. 6. As illustrated in FIG. 7A, the electrode pattern 17a on the front surface of the PCB 17 is connected to the electrode pad 16a on the rear surface of the FPC 16 with a solder S11. Then, the operator of the soldering determines the position of the electrode pad 16a on the electrode pattern 17a so that the right end of the electrode pattern 17a is aligned with the right end of the electrode pad 16a while visually checking the alignment marks 16m-1, 16m-2, 17m-1, 17m-2, 17m-3, and 17m-4. Moreover, the cover material 19a covering part of the alignment marks 16m-1 and 16m-2 is formed on the front surface of the FPC 16. Similarly, a cover material 19b covering the signal pattern S and the like is formed on the rear surface of the FPC 16. Furthermore, the electrode pad 16a of the FPC 16 is provided with a through hole T1 for electrically connecting the rear surface and front surface of the FPC 16 together. Note that the electrode pad 16a may be provided with a plurality of through holes T1 without being limited to one.

FIG. 7B is a cross-sectional view taken along line B-B′ of FIG. 6. As illustrated in FIG. 7B, the electrode pattern 17c on the front surface of the PCB 17 is connected to the electrode pad 16c on the rear surface of the FPC 16 with a solder S12. Then, the operator of the soldering determines the position of the electrode pad 16c on the electrode pattern 17c so that the right end of the electrode pattern 17c is aligned with the right end of the electrode pad 16c while visually checking the alignment marks 16m-1, 16m-2, 17m-1, 17m-2, 17m-3, and 17m-4. Moreover, the cover material 19a covering part of the alignment marks 16m-1 and 16m-2 is formed on the front surface of the FPC 16. Similarly, the cover material 19b covering the ground pattern G and the like is formed on the rear surface of the FPC 16. Furthermore, the electrode pad 16c of the FPC 16 is provided with a through hole T2 for electrically connecting the rear surface and front surface of the FPC 16 together. Note that the electrode pad 16c may be provided with a plurality of through holes T2 without being limited to one.

### Second Modified Embodiment

The second modified embodiment will be described next. An optical module according to the second modified embodiment has a configuration similar to that of the optical module 10 according to the above-described first modified embodiment except for alignment marks. Therefore, in the second modified embodiment, components common to those of the first modified embodiment will be denoted by the same reference numerals and the detailed description thereof will be omitted.

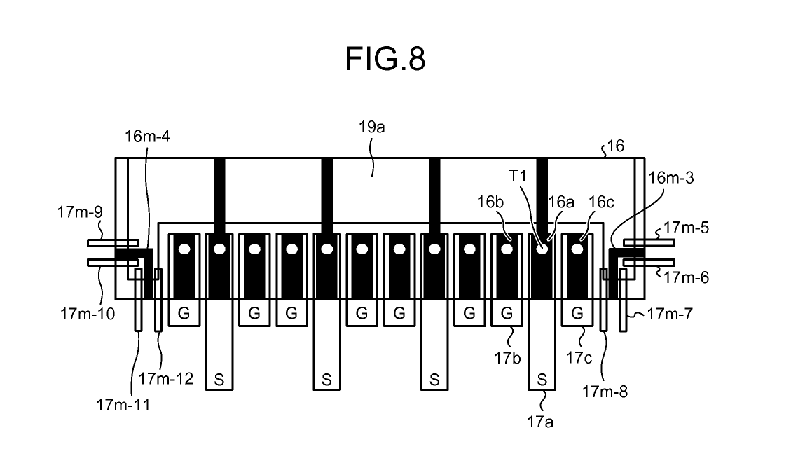

FIG. 8 is a top view illustrating a connection between the PCB 17 and the FPC 16 according to the second modified embodiment. As illustrated in FIG. 8, two alignment marks 16m-3 and 16m-4 are formed in two directions perpendicular to each other (in an inverted L shape) on the front surface of the FPC 16. Corresponding to these alignment marks, alignment marks 17m-5 and 17m-6 are formed at positions interposing the right end of the alignment mark 16m-3 therebetween on the front surface of the PCB 17. Alignment marks 17m-7 and 17m-8, on the other hand, are formed at positions interposing the lower end of the alignment mark 16m-3 therebetween on the front surface of the PCB 17. Similarly, alignment marks 17m-9 and 17m-10 are formed at positions interposing the left end of the alignment mark 16m-4 therebetween on the front surface of the PCB 17. Alignment marks 17m-11 and 17m-12, on the other hand, are formed at positions interposing the lower end of the alignment mark 16m-4 therebetween on the front surface of the PCB 17.

With the above-described configuration, the operator of the soldering can simultaneously perform alignment in a vertical direction (longitudinal direction of the electrode pad 16a) and alignment in a horizontal direction (longitudinal direction of the FPC 16) between the electrode pattern 17a of the PCB 17 and the electrode pad 16a of the FPC 16. Therefore, the optical module 10 can easily deal with displacement in the horizontal direction as well as displacement in the vertical direction. As a result, alignment accuracy is further improved.

Note that it is sufficient for the cover material 19a to cover part of the alignment marks 16m-3 and 16m-4 so that ends thereof are exposed. An area covering the alignment marks 16m-3 and 16m-4 may be set as desired within a range capable of suppressing the separation thereof.

### Third Modified Embodiment

The third modified embodiment will be described next. An optical module according to the third modified embodiment has a configuration similar to that of the optical module 10 according to the above-described second modified embodiment except for alignment marks. Therefore, in the third modified embodiment, components common to those of the second modified embodiment will be denoted by the same reference numerals and the detailed description thereof will be omitted.

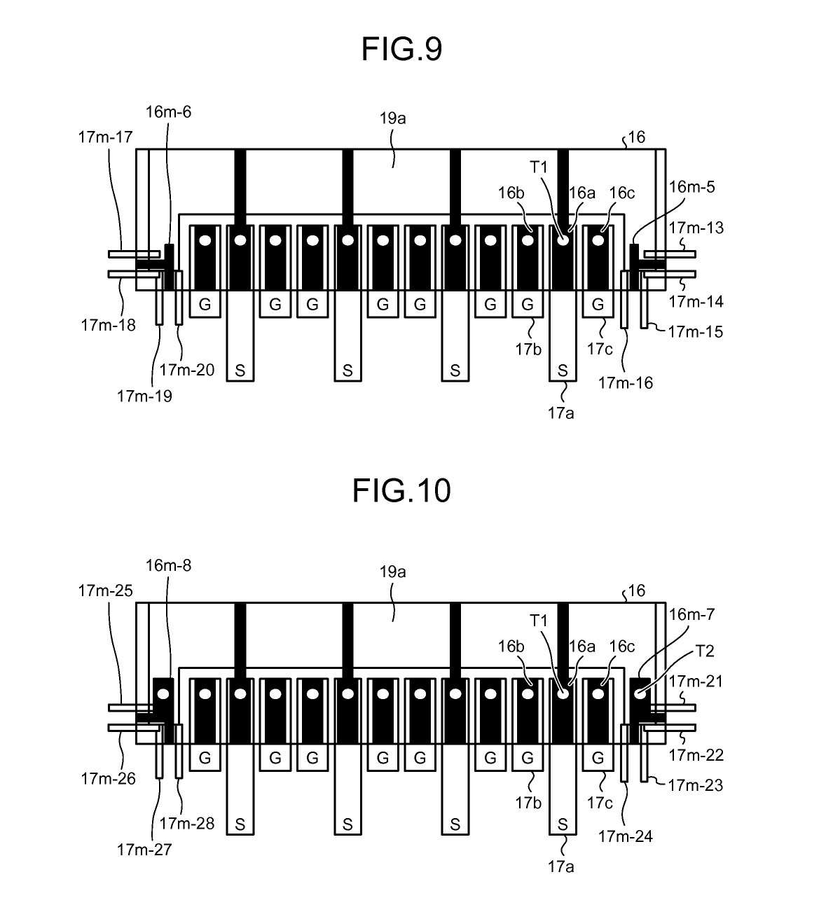

FIG. 9 is a top view illustrating a connection between the PCB 17 and the FPC 16 according to the third modified embodiment. As illustrated in FIG. 9, two alignment marks 16m-5 and 16m-6 are formed in two directions perpendicular to each other (in a horizontally-oriented T shape) on the front surface of the FPC 16. Corresponding to these alignment marks, alignment marks 17m-13 and 17m-14 are formed at positions interposing a right end of the alignment mark 16m-5 therebetween on the front surface of the PCB 17. Alignment marks 17m-15 and 17m-16, on the other hand, are formed at positions interposing the lower end of the alignment mark 16m-5 therebetween on the front surface of the PCB 17. Similarly, alignment marks 17m-17 and 17m-18 are formed at positions interposing the left end of the alignment mark 16m-6 therebetween on the front surface of the PCB 17. Alignment marks 17m-19 and 17m-20, on the other hand, are formed at positions interposing the lower end of the alignment mark 16m-6 therebetween on the front surface of the PCB 17.

When the right end of the alignment mark 16m-5 and the left end of the alignment mark 16m-6 are close to the tip portions of the FPC 16 for the reason of, for example, a short length of the electrode pad 16a or the like, the alignment marks 16m-5 and 16m-6 may be formed in the horizontally-oriented T shape as illustrated in FIG. 9. Consequently, adhered portions between the alignment marks 16m-5 and 16m-6 and the FPC 16 extend toward the package side, thereby increasing the adhered area. As a result, strength at the adhered portion is increased, thereby making it possible to suppress the separation thereof. Moreover, variations in lengths of the electrode pattern 17a of the PCB 17 and the electrode pad 16a of the FPC 16 can be dealt with flexibly.

Note that it is sufficient for the cover material 19a to cover part of the alignment marks 16m-5 and 16m-6 so that ends thereof are exposed. An area covering the alignment marks 16m-5 and 16m-6 may be set as desired within a range capable of suppressing the separation thereof.

Alternatively, when there is an enough space to form the alignment marks 16m-5 and 16m-6, the two alignment marks 16m-5 and 16m-6 may be formed not in the horizontally-oriented T shape but in a vertically-oriented T shape (normal T shape) or in a cross shape. Note however that the alignment mark 16m-5 is not necessarily formed with an intersection at a right angle. The alignment mark 16m-5 may be formed with an intersection making an obtuse angle (dogleg shape) or an acute angle. Furthermore, the two alignment marks 16m-5 and 16m-6 formed at the both ends of the FPC 16 do not necessarily have the same shape. An L shape, a T shape, a cross shape, and the like, may be appropriately combined with one another.

### Fourth Modified Embodiment

The fourth modified embodiment will be described next. An optical module according to the fourth modified embodiment has a configuration similar to that of the optical module 10 according to the above-described third modified embodiment except for alignment marks. Therefore, in the fourth modified embodiment, components common to those of the third modified embodiment will be denoted by the same reference numerals and the detailed description thereof will be omitted.

FIG. 10 is a top view illustrating a connection between the PCB 17 and the FPC 16 according to the fourth modified embodiment. As illustrated in FIG. 10, two alignment marks 16m-7 and 16m-8 are formed on the front surface of the FPC 16 so as to be thinner in the vicinity of the end of the FPC 16 and thicker in the other portion (center side). This further reduces the possibility of the separation of the alignment marks 16m-7 and 16m-8. Moreover, by providing a through hole T2 in each of the thickly-formed portions of the alignment marks 16m-7 and 16m-8, a level of adhesion of the alignment marks 16m-7 and 16m-8 with the FPC 16 can be further improved.

Note that the width of the alignment marks 16m-7 and 16m-8 may be increased gradually (for example, a tapered shape).

### Fifth Modified Embodiment

The fifth modified embodiment will be described next. An optical module according to the fifth modified embodiment has a configuration similar to that of the optical module 10 according to the above-described second modified embodiment except for the cover material. Therefore, in the fifth modified embodiment, components common to those of the second modified embodiment will be denoted by the same reference numerals and the detailed description thereof will be omitted.

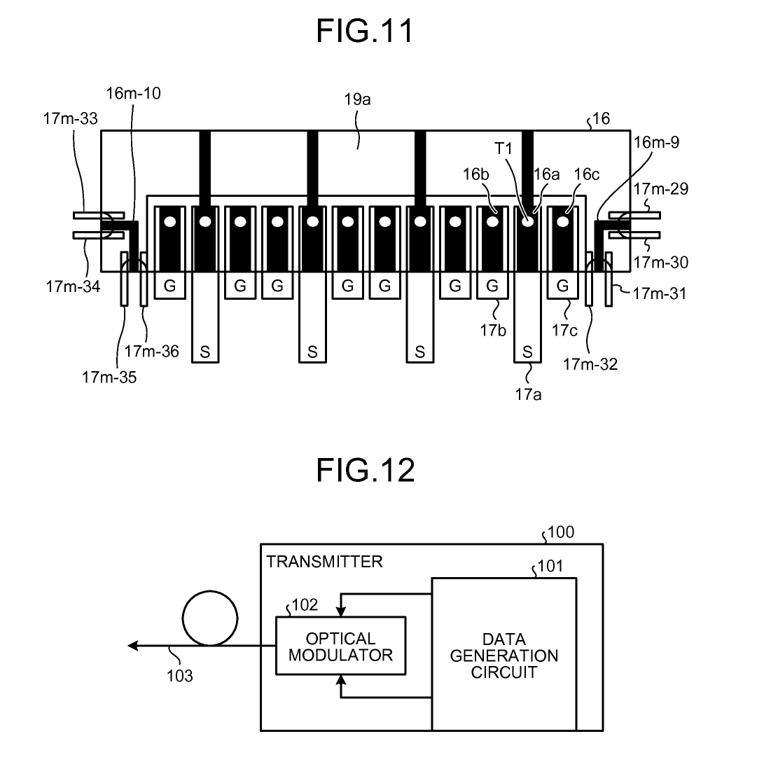

FIG. 11 is a top view illustrating a connection between the PCB 17 and the FPC 16 according to the fifth modified embodiment. As illustrated in FIG. 11, the cover material 19a has a semicircular opening in each of the right end and the lower end of an alignment mark 16m-9 and the left end and the lower end of an alignment mark 16m-10. This allows for the drilling of the cover material 19a. Therefore, the optical module 10 can maintain the visibility of the alignment marks 16m-9 and 16m-10 without complicating the machining of the outer shape of the cover material 19a.

Note that it is sufficient for the cover material 19a to cover part of the alignment marks 16m-9 and 16m-10 so that ends thereof are exposed. An area covering the alignment marks 16m-9 and 16m-10 may be set as desired within a range capable of suppressing the separation thereof. Moreover, the shape of the opening of the cover material 19a may be any shape including, without being limited to the semicircular shape, a rectangular shape, a triangular shape, a rhomboid shape, and the like, within a range so as not to block the visual checking by the operator of the soldering. Furthermore, the openings formed at the both ends of the FPC 16 do not necessarily have the same shape. A semicircular shape, a rectangular shape, a triangular shape, a rhomboid shape, and the like, may be appropriately combined with one another.

### Application Example

An optical modulator employing the above-described optical module 10 may be effectively applied to a transmitter, for example, since such an optical modulator can simultaneously achieve improved high-frequency characteristics and high mountability. FIG. 12 is a diagram illustrating a configuration of a transmitter 100 in which the optical module 10 according to any one of the above-described embodiment and modified embodiments is mounted. As illustrated in FIG. 12, the transmitter 100 includes a data generation circuit 101, an optical modulator 102, and an optical fiber 103. These components are connected to one another unidirectionally or bidirectionally so as to enable the input and output of various signals or data. Data generated by the data generation circuit 101 is converted from an electric signal into an optical signal by the optical modulator 102. The data is then transmitted to the outside of the device with the optical fiber 103 used as a transmission medium. Note that the optical module 10 may be applied to a receiver without being limited to the transmitter.

In the above-described embodiment and modified embodiments, the method for improving alignment accuracy has been described taking the solder connection between the FPC and the PCB as an example. However, the solder connection is not limited thereto. The same effect can be obtained also in a solder connection between an FPC and an FPC or between a PCB and a PCB, for example. Moreover, while the application to the optical modulator 102 has been illustrated in the present example, the application is not limited thereto. The present invention can be applied to another device including a substrate to be connected to other substrate.

Moreover, the alignment marks 16m-1, 16m-2, . . . , and 16m-10 on the FPC 16 have been described in the above-described embodiment and modified embodiments with the tip portion thereof being exposed from the cover material 19a. The exposed portion of the alignment marks 16m-1, 16m-2, . . . , and 16m-10, however, is not limited to the tip portion. Part of the alignment marks 16m-1, 16m-2, . . . , and 16m-10 may be exposed in the vicinity of the center portion thereof, for example. Furthermore, the alignment marks 16m-1, 16m-2, . . . , and 16m-10 are not necessarily formed at the both sides on the FPC 16. They may be formed only at one side of the FPC 16. Moreover, the alignment marks 16m-1, 16m-2, . . . , and 16m-10 are not necessarily formed only at the both sides on the FPC 16. They may be formed at three or more positions.

Moreover, in the description set forth above, the individual configurations and operations for the individual embodiment and modified embodiments have been described. However, the optical modules 10 according to the above-described embodiment and modified embodiments each may also have a component particular to the other modified embodiment. A combination of the embodiment and modified embodiments is not limited to two. Any configuration is possible such as a combination of three or more of the embodiment and modified embodiments. For example, the optical module 10 according to the third and fourth modified embodiments may have the cover material 19a according to the fifth modified embodiment on the front surface of the FPC 16. Furthermore, a single optical module 10 may possess all components described in the above-described embodiment and first to fifth modified embodiments within a compatible range.

According to the embodiment of the optical module disclosed by the present application, high-frequency characteristics can be improved.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An optical module comprising:
a first substrate that includes a first electrode and a first mark; and
a second substrate that includes a second electrode and a second mark, wherein the second substrate is formed so that at least part of the first mark is exposed in the vicinity of the second mark when the second electrode is electrically connected to the first electrode.

2. The optical module according to claim 1, wherein the second substrate includes a cover material that covers part of the second mark on a surface different from the second electrode.

3. The optical module according to claim 1, wherein the second mark is formed in an L shape.

4. The optical module according to claim 1, wherein the second mark is formed in a T shape.

5. The optical module according to claim 2, wherein the second mark is formed so that the part covered by the cover material is thicker than other parts.

6. The optical module according to claim 2, wherein the cover material is provided with a semicircular opening that exposes part of the second mark.
